(19) United States
(12) Patent Application Publication
(10) Pub. No.: US 2011/0182697 A1
(43) Pub. Date: Jul. 28, 2011

(54) Multi-rod thread clamping device

(76) Inventor: Ronald A. Smith, Los Gatos, CA (US)

(21) Appl. No.: 12/931,138

(22) Filed: Jan. 25, 2011

Related U.S. Application Data
(60) Provisional application No. 61/336,646, filed on Jan. 25, 2010.

(51) Int. Cl. F16B 37/08

(52) U.S. Cl. 411/433

(57) ABSTRACT

Thread clamping devices are described in which a single such device is capable of robustly engaging with different threaded rods having different thread configurations. Such devices include a plurality of threaded, movable segments wherein the threads of each segment are capable of robust engagement with the threads of a rod, and different segments or groups of segments have thread configurations capable of binding with different rod thread structures.

### CROSS-REFERENCE TO RELATED APPLICATIONS

This application claims priority from provisional patent application Ser. No. 61/336,646 filed Jan. 25, 2010 pursuant to one or more of 35 U.S.C. 119, §120, §365. The entire contents the cited provisional patent application is incorporated herein by reference for all purposes.

### BACKGROUND OF THE INVENTION

1. Field of the Invention

The present invention relates to a female threaded fastener or thread clamping device wherein a single device is capable of robustly engaging threaded rods of different diameters as well as threaded rods having different thread configurations, including both English (inch) and metric rods and threads.

2. Description of the Prior Art

The fastener industry employs many examples of threaded female fasteners with moving segments that facilitate quick connection or assembly of the fastener to the threaded rod when assembled in one direction along the threaded rod, but locks when motion is attempted in the opposite direction along the threaded rod. That is, the fastener can be moved along a threaded rod in one direction rapidly and without rotation (hereinafter the “ratcheting” direction), but locks when translational motion without rotation is attempted along the rod in the opposite direction (hereinafter the “locking” direction). Thus, rotation of the fastener is required to move the fastener in the locking direction. Upon moving the fastener to the desired position in the ratcheting direction and applying an external torque to tighten the fastener, the torque applied to the fastener will drive the segments into the threaded rod if the fastener base can rotate, but not cause the fastener to move axially along the rod, thus providing locking friction between the segment threads and the rod threads.

However, existing fasteners can be used only with the particular thread configuration and only with a rod of the correct diameter for which the fastener was designed. That is, different fasteners are required for each rod diameter and for each thread configuration. Thus, a need exists in the art for fasteners capable of clamping robustly to rods of different diameters and to rods having different thread configurations, in particular, fasteners capable of clamping robustly to rods and threads fabricated according to either English (inch) or metric standards or to rods having different threads within the same standard.

### SUMMARY OF THE INVENTION

One important characteristic of the fasteners described herein (referred to as “Multi-Thread Clamping Device” or M-TCD) is that the M-TCD is capable of successfully and robustly engaging two or more rods with totally different threads. That is, a single M-TCD as described herein can be used to engage any rod chosen from a group of rods having different thread structures and/or rod diameters. The diameter range of different rods and the number of different thread types that can be engaged by a single M-TCD depends on several factors in the structure of the particular M-TCD as described more fully below.

In brief, the M-TCDs described herein engage the threads on a threaded rod (or simply “rod”) by means of a number of threaded, movable segments wherein the threads of each segment are capable of robust engagement with the threads of a rod, typically different segments or groups of segments capable of binding with different thread structures.

The structure of threads on threaded rods may be defined according to profile geometry, diametral pitch, axial pitch and dimension, among other characteristics. See for example, Machinery's Handbook, 28^{th} Ed. (Industrial Press, 2008), pp. 1708-2026. The diameter of the rod also affects the geometry of the threads. For economy of language, we use “thread type”, “thread structure”, “thread geometry” and the like to denote a particular thread on a rod with a particular diameter.

The movable segments of the M-TCD typically have different thread structures capable of engaging corresponding thread structures on different types of rods. That is, each movable segment (or set of segments) of an M-TCD will be designed to meet the standards for a particular thread on a particular rod. Thus, if the particular M-TCD has segments meeting the standards for N different thread types, that single type of M-TCD is suitable for engaging N different thread types (limited by geometrical factors in that rods having substantially different diameters cannot both engage robustly with the segments of a single M-TCD since a single M-TCD cannot conveniently bring segments into intimate engagement with rods of very different diameters).

Advantageously, these various movable segments having different threads within a typical M-TCD are considered in “sets” wherein each segment in a given “set” has the same thread structure. The individual segments comprising such sets are advantageously disposed more or less in an equidistant polar configuration about the M-TCD central axis. That is, a segment set is generally a group of threaded movable segments typically having approximately the same physical size with the same thread pitch diameter and the same thread pitch (the axial distance between the same features on adjacent threads). All segments typically produce an inward radial force component when the segment threads are engaged by the rod threads in a locking direction. “Balanced” and “unbalanced” segment sets may exist. A balanced segment set produces inward radial force vectors that sum substantially to zero. An unbalanced segment set produces inward radial force vectors that do not sum to zero. If there are an even number of total segments within the M-TCD, then each segment set is inherently balanced as long as each segment set has the following properties.

(a) Each segment set has the same total number of segments as any other segment set.

(b) Each segment set has all segments configured in an equidistant polar array.

(c) All the segments within a segment set are approximately the same physical size. An M-TCD with an odd total number of segments typically will have unbalanced segment sets. Each segment of a particular segment set has a specific thread geometry comprising a specific thread pitch diameter and thread pitch axially along the rod. Each segment within the segment set will typically have the same thread geometry. However the thread phase may vary from segment to segment. Thread phase is most readily understood by considering a hypothetical operation of axially cutting a standard threaded nut into four equal quarters, the quarters of this divided standard nut are analogous to segments of the M-TCD. If any the position around the perimeter of any of the two nut quarters are exchanged and then all quarters are reconnected (welded) together, the resulting re-assembled nut would not engage (or screw) on to a threaded rod because the threads of the re-assembled nut are out of phase with respect to the two quarters of the original nut that were exchanged. In contrast, an M-TCD will operate correctly whether or not the segments within a segment set have the same thread phase because the segments are movable and will align to the phase of the rod thread.

Each segment set of the M-TCD engages a rod with a matching thread and will not engage a threaded rod with a mismatched thread (a rod with a different thread pitch diameter and/or axial thread pitch). It is possible for a particular segment having a particular thread structure to engage more than one threaded rod having slightly different thread pitch diameters (approximately within 15% of each other), but the axial thread pitch must be almost identical to achieve proper thread engagement with the segments of that particular segment set. There is no theoretical limit to the total number of segment sets within the M-TCD, however an M-TCD having two segment sets seems to offer cost effective manufacturing and adequate performance. Thus, to be concrete in our description, the M-TCDs described herein are typically shown as having two segment sets and two segments within each segment set for a total of four segments. Other configurations and numbers of segments and segment sets are clearly envisioned within the scope of this invention, and a few illustrative examples will also be described. But for the particular M-TCD having two segment sets and four total segments, the same M-TCD fastener can be constructed so as to engage with a threaded rod with an American National and Unified Screw Thread Form (typically referred to as “English” or “inch” threads) as well as a threaded rod with an American National Standard Metric Screw Thread (typically referred to as “Metric” threads). The actual thread profile of both thread systems is identical. However the pitches and diameters are different for most standard sizes within each system. To be concrete in our discussions herein we shall use the terms US thread and Metric thread to differentiate between the two systems. In the US system there are two typical thread pitches, a coarse pitch (referred to as UNC or Unified National Coarse) and a fine pitch (referred to as UNF or Unified National Fine). The same is true in the Metric system, but the capabilities described herein apply equally within each thread system and between both thread systems.

In view of the foregoing, in accordance with the various embodiments of the present invention, there is provided a family of M-TCDs able to move along a threaded rod in one direction without rotation (“ratcheting direction”), and further, will not move in the opposite direction without rotation (“locking direction”). Each time the M-TCD moves (slides) at least a one half (½) thread in the downward (ratcheting) direction, the M-TCD is configured to internally ratchet and lock in place, thus preventing the M-TCD from moving upward (in the locking direction) with respect to the (presumed vertical) threaded rod.

Additionally, an advantage of the M-TCD over a traditional hex nut is that the M-TCD will engage many damaged threaded rods successfully where even a substantial portion of the threads of the rod have been deformed to the point where the standard hex nut will jam. These and other features and advantages of the present invention will be understood upon consideration of the following detailed description of the invention and the accompanying drawings.

### BRIEF DESCRIPTION OF THE DRAWINGS

It should be noted here that some of the following drawings depict internal and/or external threads. The threads illustrated are for explanation purposes and do not always show a true spiral because of imprecision of the CAD software application used to generate the drawings, however the thread profile is accurate. The description of various embodiments of the invention is not affected by this drawing imprecision.

The drawings herein are schematic and not generally to scale. They are not intended to depict absolute or relative dimensions of devices or components.

FIG. 1 is a perspective view of a typical M-TCD on a threaded rod.

FIG. 2 is a top view of a typical M-TCD.

FIG. 3 is a side view of a typical M-TCD.

FIG. 4 is an exploded perspective view of a typical M-TCD.

FIG. 5 is a top view of the base of a typical M-TCD.

FIG. 6 is a sectioned view of the base defined by Section CC in FIG. 5.

FIG. 7 is a three dimensional top perspective view of a typical M-TCD with cap removed.

FIG. 8 is a sectioned view of the cap only, defined by Section AA in FIG. 2.

FIG. 9 is a sectioned view of an entire M-TCD defined by Section AA in FIG. 2.

FIG. 10 is a sectioned view of an entire M-TCD defined by Section BB in FIG. 2.

FIG. 11 is a close up outer perspective view of a single segment (or movable segment) with smaller thread pitch (more threads per axial inch) than the segment shown in FIG. 12.

FIG. 12 is a close up outer perspective view of a single movable segment with larger thread pitch (less threads per axial inch) than the segment shown in FIG. 11.

FIG. 13 to FIG. 22 are schematic top view representations of various M-TCD segment and segment set configurations. Components designated as “A”, “B”, “C” in these figures, whether or not followed by a numerical suffix, indicate distinct segments.

FIG. 13. A balanced four segment M-TCD.

FIG. 14. An unbalanced four segment M-TCD.

FIG. 15. An unbalanced three segment M-TCD.

FIG. 16. A balanced five segment M-TCD.

FIGS. 17-18. Unbalanced five segment M-TCDs.

FIG. 19. A balanced six segment M-TCD.

FIG. 20. A balanced six segment M-TCD.

FIG. 21. An unbalanced six segment M-TCD.

FIG. 22. A balanced twelve segment M-TCD.

### DETAILED DESCRIPTION

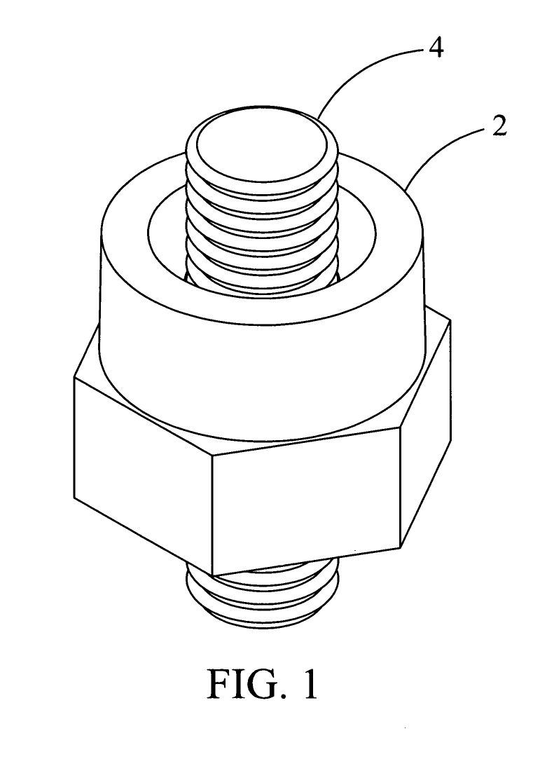

FIG. 1 is a perspective view of a typical M-TCD engaged to a threaded rod (“Rod”) 4 in pursuant to some embodiments of the present invention.

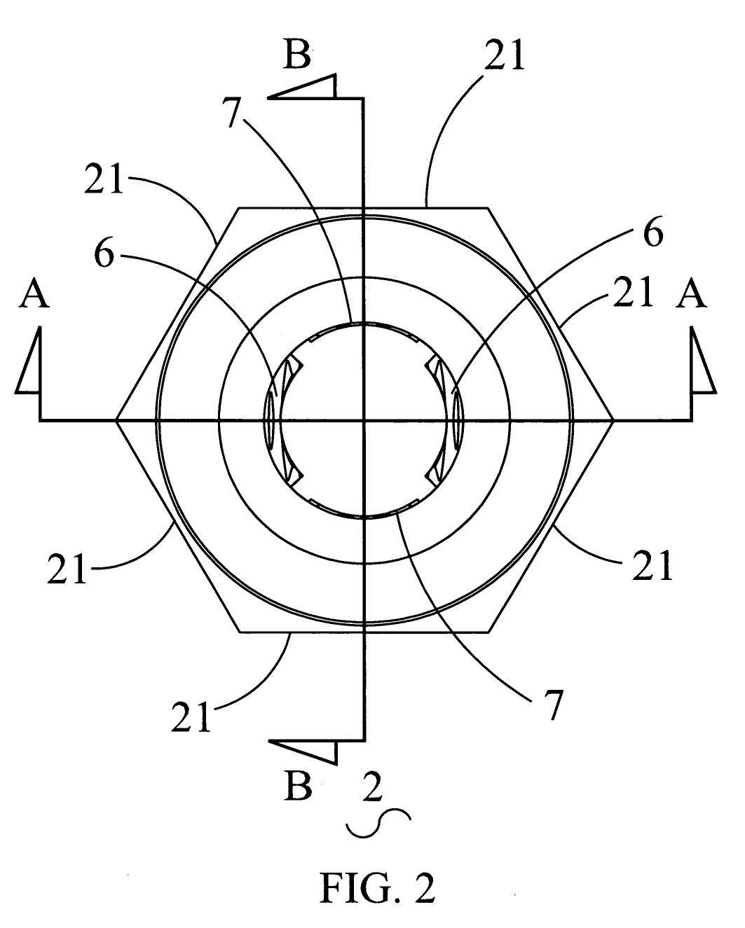

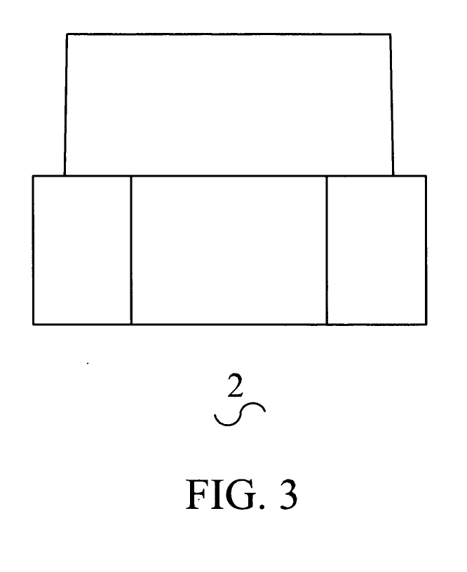

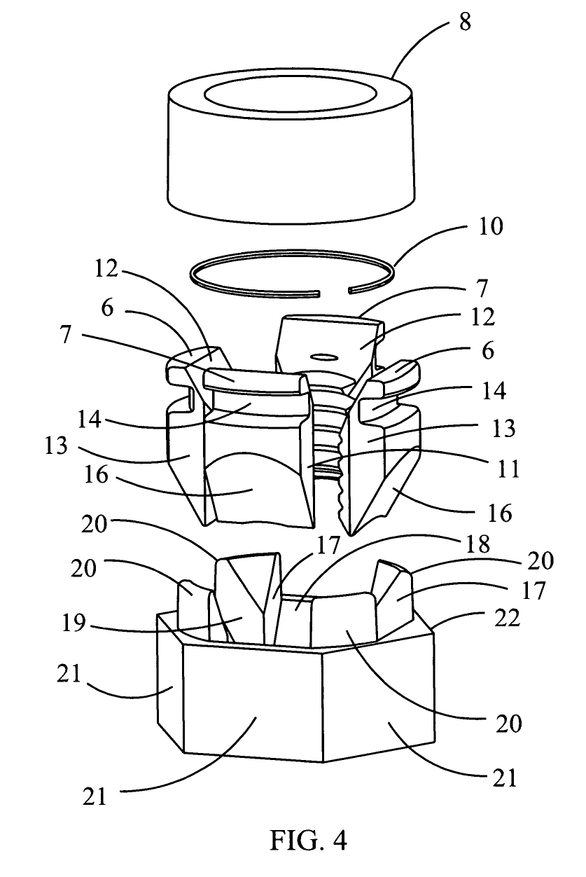

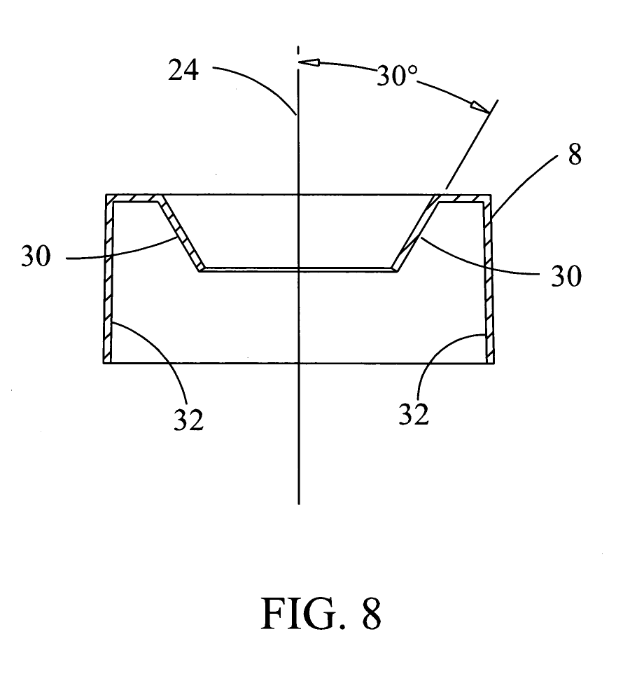

FIG. 2 and FIG. 3 show top view, and side view respectively of a typical M-TCD. FIG. 4 shows in exploded view a typical M-TCD including a base 22, movable segments (“segments”) 6 and movable segments (“segments”) 7 supported by base 22, and a cap 8 engaging base 22 with one or more posts 20. Segments 6 and segments 7 are contained within cap 8. Surrounding segments 6 and segments 7 is spring 10. For the particular embodiment depicted in FIG. 2, we depict two segment sets, one set having two segments 6, and another set having two segments 7, symmetrically positioned about the central axis 24 of the M-TCD (FIG. 8). In one embodiment of the present invention, both segments 6 are identical, both segments 7 are identical but different from segments 6, resulting in a balanced four segment M-TCD.

Hex surface 21 is depicted in FIG. 2 as one convenient configuration for base 22. It is to be noted that while the base 22 is shown with substantially hexagonal side surfaces, within the scope of the present invention, the base 22 of the M-TCD typically includes cubic, square and any other tubular configuration capable of accommodating threaded rod 4, and which is capable of including the components and features of the M-TCD as discussed in further detail below.

FIG. 4, illustrates a complete (four segment balanced) M-TCD with all parts depicted in exploded view. Four posts 20 are shown on base 22. The four posts 20 on base 22 are used to couple cap 8 to base 22. Within the scope of the present invention, depending upon the shape of M-TCD among other considerations, a fewer or greater number of posts 20 may be used.

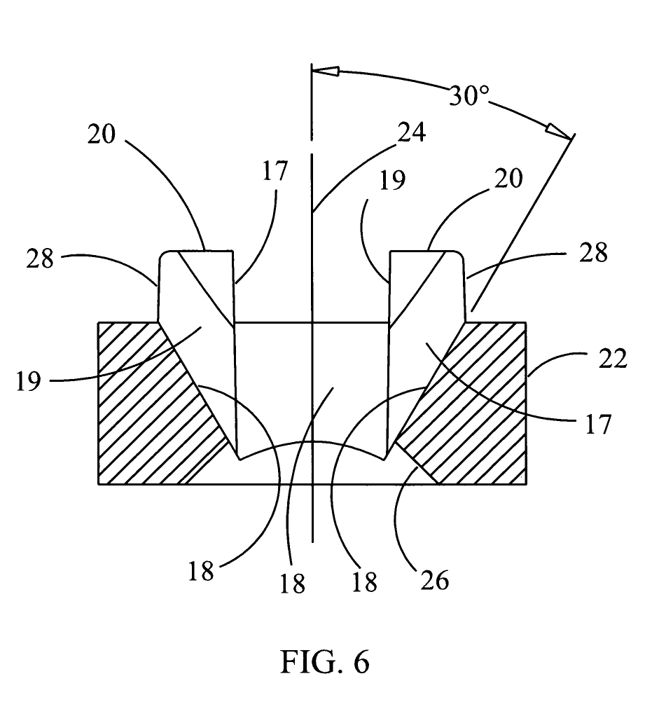

Spring 10 is shown above base 22. Also in FIG. 4, segments 6 and segments 7 are shown directly below spring 10. Cap 8 is also depicted above segments 6 and segments 7. All the parts illustrated in FIG. 4, when assembled, comprise one typical example of a complete M-TCD as would be employed for actual field uses. Also shown in FIG. 4 are load bearing surfaces (or “surfaces”) 18 in base 22. There are, in this example, four load-bearing surfaces 18 arranged in an equidistant polar array relative to central axis 24 in base 22 (see FIG. 6). This M-TCD has its central axis 24 coincident with the axis of threaded rod 4. Left segment guide surface 17, load-bearing surface 18 and right segment guide surface 19 are defined to be a “feature set”. Also load-bearing surface 18 is advantageously designed to be about 30 degrees relative to central axis 24. FIG. 4 also shows a segment spring groove 14. There is one groove 14, one upper guide surface 12 and one segment load-bearing surface 16 for each segment 6 and segment 7.

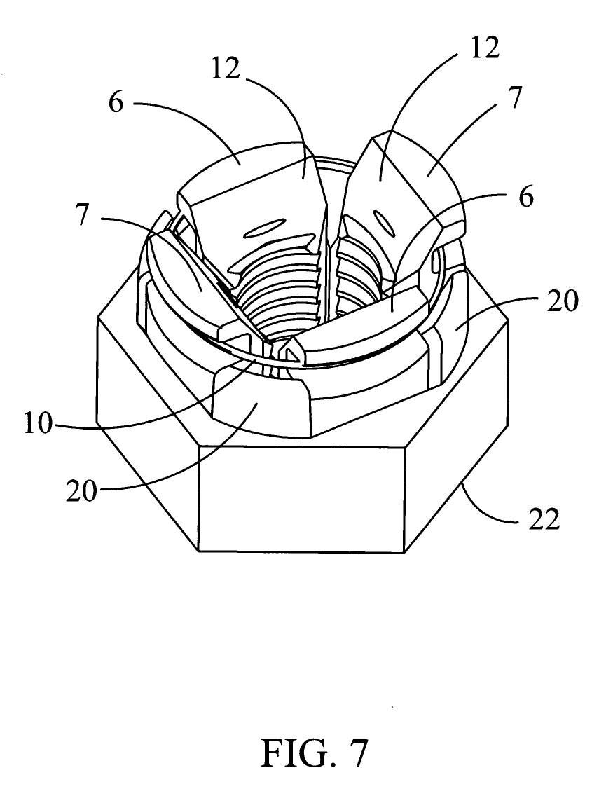

In the following descriptions various configurations of segment sets will be described. Segment sets for segments 6 and segments 7 are shown in FIG. 2, FIG. 4 and FIG. 7. Segments within a segment set typically have the same thread geometry. While the thread phase could be different among segments within a segment set it is more economical if all the segments within a set are identical.

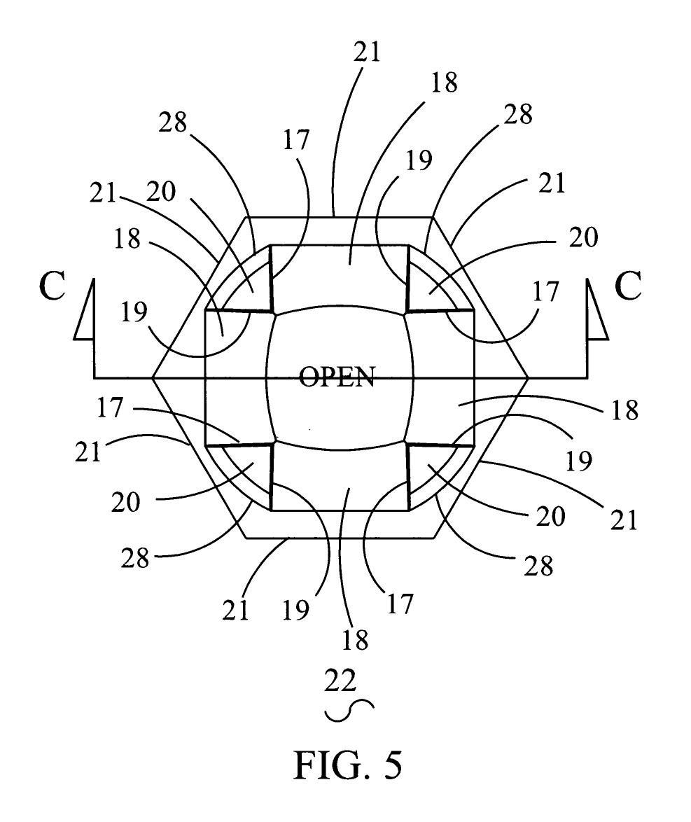

FIG. 5 is a top view of base 22. Shown in top view are surfaces 17, 18, 19 and 21.

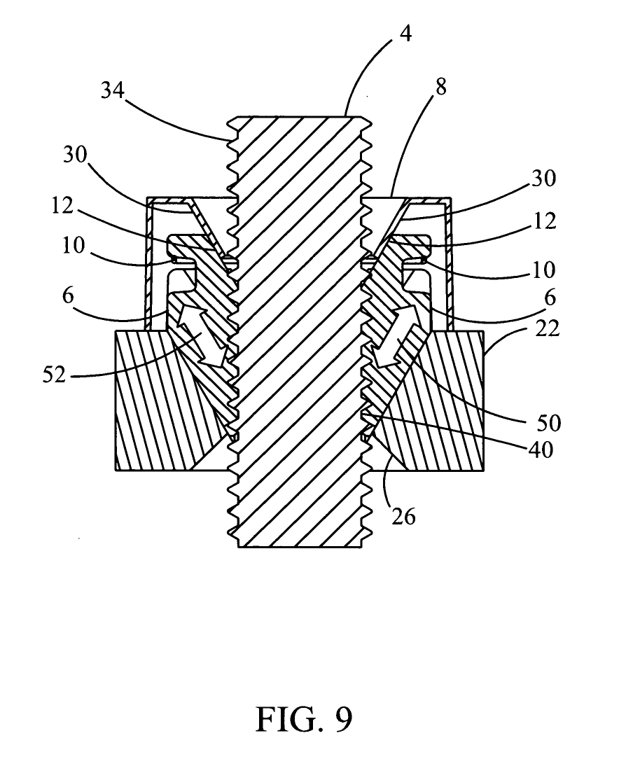

FIG. 6 shows load-bearing surfaces 18 at a 30 degree angle to central axis 24. Now referring back to FIG. 4, in an assembled configuration, segment load-bearing surfaces 16 bear against load-bearing surfaces 18 of base 22. During application of clockwise torque upon hex surfaces 21 of base 22, left segment guide surfaces 17 engage segment right side surface 11 of segment 6 and cause segments 6 to rotate clockwise (when viewed from above in the sense of FIG. 4) about rod 4. Similarly during application of counter clockwise torque upon hex surfaces 21 of base 22, right segment guide surface 19 of base 22 engages segment left side surfaces 13 of segment 6 and cause segments 6 to rotate counter clockwise about rod 4. It should be noted that M-TCD will operate correctly even if left segment guide surface 17 of base 22 and right segment guide surface 19 of base 22 do not engage segment right side surface 11 of segment 6 and segment left side surface 13 of segment 6 respectively, provided that load-bearing surface 18 of base 22 is engaged with segment load-bearing surface 16 of segment 6. It should also be noted that, although both sets of segments 6 and segments 7 are rotated with respect to rod 4 as the entire M-TCD is rotated, for the particular example considered here, only segments 6 actually engage the rod threads (as shown in FIG. 9) and segments 7 do not engage the threads of rod 4 since the threads of segments 6, in this embodiment, are assumed to have been fabricated so as to match the threads of rod 4 while the threads of segments 7 are assumed to have been fabricated so as to mismatch the threads of rod 4 (as shown in FIG. 10). Segments 7 would be suitable for engaging a different rod 4 having matching threads with those of segments 7 while, in this alternate example, segments 6 would not engage this different threaded rod 4. Thus, the use of different segments for segments 6 and segments 7 permit this example of an M-TCD to function properly for two different rods.

FIG. 7 is an upper perspective view of base 22 depicting segments 6 with spring 10 in segment spring grooves 14. Segments 6 are shown in an engaged position and segments 7 are shown in a disengaged position in this example.

FIG. 8 is a sectioned view of cap 8 as defined by Section AA as shown in FIG. 2. Cap 8 provides two basic functions. First, cap 8 retains segments 6 and segments 7 within the M-TCD using a press fit between press fit cap surface 32 and base post surfaces 28 shown in FIG. 5. The second function of cap 8 is to provide guiding force for the segments when the segments are moving away from the rod 4 during ratcheting. This guiding is accomplished by cap guiding surface 30 engaging upper guide surface 12.

FIG. 9 is a cross sectional view of M-TCD as defined by Section AA shown in FIG. 2 with segments 6 engaged with threaded rod 4 in accordance with some embodiments of the present invention. Also shown in cross section is cap 8, and base 22 along with spring 10. Also shown are motion direction arrows 50 and 52 that define the direction of motion of segments 6 during ratcheting.

FIG. 10 is a cross sectional view of M-TCD as defined by Section BB shown in FIG. 2 with segments 7 disengaged from rod 4. Segment threads 46 (mismatched threads in this example) are shown disengaged with rod threads 34 in accordance with some embodiments of the present invention. Also shown in cross section is cap 8, and base 22 along with spring 10. Motion direction arrows are not shown in FIG. 10 since segments 7 have mismatched threads 46 with respect rod threads 34 and therefore remain disengaged at all times.

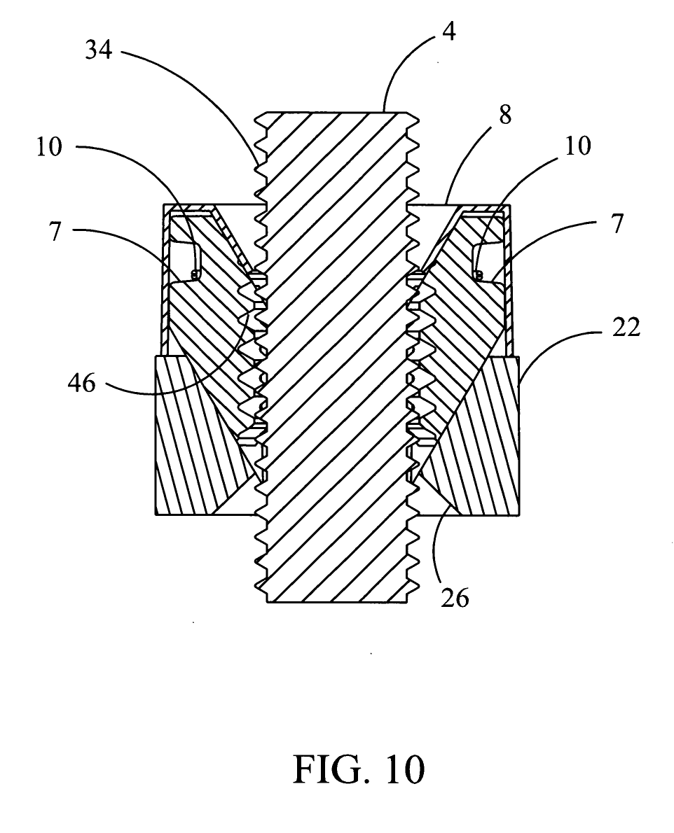

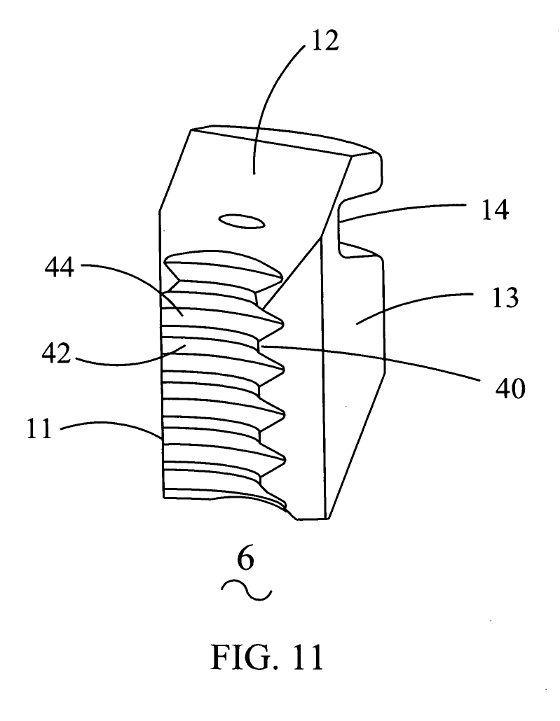

FIG. 11 is a perspective view of movable segment 6. The threads 40 of segment 6 threads are chosen in this example to match the thread geometry 34 of rod 4 and therefore engage the threads of rod 4.

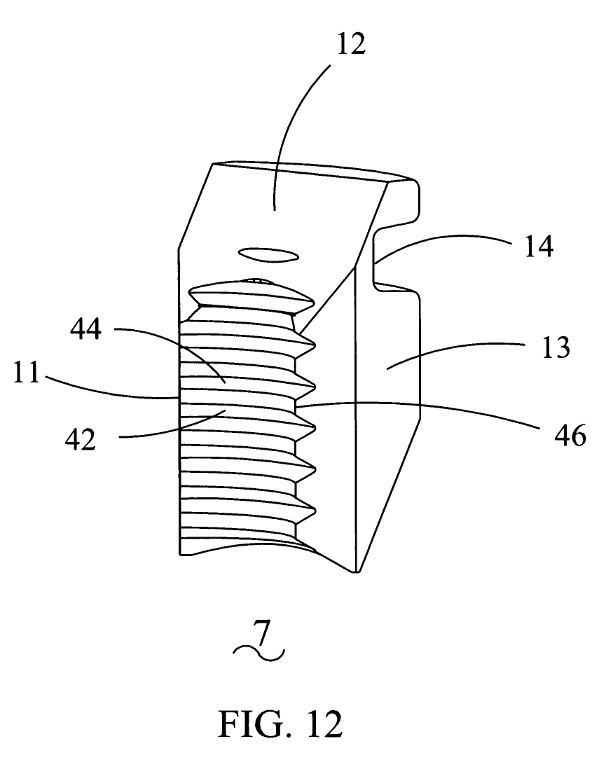

FIG. 12 is a perspective view of movable segment 7. The threads 46 do not match the threads of rod 4. The thread pitch of segment 7 may be more or less than the pitch of thread 34 of rod 4.

FIG. 13 is a schematic depiction of a typical M-TCD which has four total segments 56, 58. The segments 56 and 58 within M-TCD 54 represent two balanced segment sets 56 and balanced set 58. Segments 56 are labeled A and segments 58 are labeled B. In the M-TCD 54 configuration all segments are shown as approximately the same size and therefore segment sets 56 and 58 are balanced since all inward force vectors sum to zero. To maintain a balanced configuration all segments 56 must be substantially the same size as all other segments 56 and all segments 58 must be substantially the same size as all other segments 58. However segments 56 may be a different size than segments 58. It is possible to have an M-TCD with a single set of segments and only two segments within the set. However, such a device would not be capable of successfully engaging two threaded rods of differing threads which is one major purpose of the M-TCD.

FIG. 14 is a schematic depiction of segments within M-TCD 60 that represent two unbalanced segment sets. Unbalanced segment set 56 and unbalanced segment set 58. All segments within M-TCD 60 are the same size as the corresponding segments 56 and 58 shown in M-TCD 54 (FIG. 13). However the inward force vectors of segments 56 and 58 do not sum to zero since each segment set is not spaced in an equidistant polar configuration about the M-TCD 60 central axis.

FIG. 15 is a schematic depiction of segments within M-TCD 66 that represent another example of two unbalanced segment sets, unbalanced segment set 62 (two segments) and unbalanced segment set 64 (a single segment). All segments within M-TCD 66 are the same size. However in any M-TCD segment configuration that has an odd number of total segments it is not possible to have a single segment in another segment set where the inward force vectors for all segment sets will sum to zero.

FIG. 16 is a schematic depiction of an M-TCD having an odd number of total segments within M-TCD 70 that comprise two balanced segment sets. Segments 58 represent a balanced set of two segments 58 and the second segment set consists of two segments 68 plus one segment 56. Two segments 68 equal the size of segment 56 for a total of three segments in the segment set where the sum of the inward force vector does sum to zero thus defining a balanced segment set. This example is disfavored for practical applications since in an actual application it is expected generally to be more economical to replace the two segments 68 with a single segment 56.

FIG. 17 and FIG. 18 are schematic depictions of five segment M-TCDs demonstrating the example of an M-TCD with an odd number of total segments (where all the segments within each segment set are the same size). The segment sets are unbalanced since the inward force vectors do not sum to zero no matter what the polar distribution of the segments about the central axis of the M-TCD.

FIG. 19 is a schematic depiction of a six segment M-TCD 86 with three balanced segment sets 80, 82 and 84. Each segment set has two equal segments and in each segment set the inward force vectors sum to zero. In each segment set there are two segments configured in an equidistant polar array about the central axis of M-TCD 86. M-TCD 86 is capable of successfully engaging three separate rods of differing thread geometry and/or diameter.

FIG. 20 is a schematic depiction of a six segment M-TCD 88 with two balanced segment sets 80 and 82. Each segment set has three equal segments and in each segment set the inward force vectors sum to zero. In each segment set there are three segments configured in an equidistant polar array about the central axis of M-TCD 88. M-TCD 88 is capable of successfully engaging two separate rods of differing thread geometry and/or diameter.

FIG. 21 is a schematic depiction of a six segment M-TCD 90 with two unbalanced segment sets 80 and 82. Each segment set has three equal segments and in each segment set the inward force vectors do not sum to zero. In each segment set there are three segments configured in a non-equidistant polar array about the central of M-TCD 90.

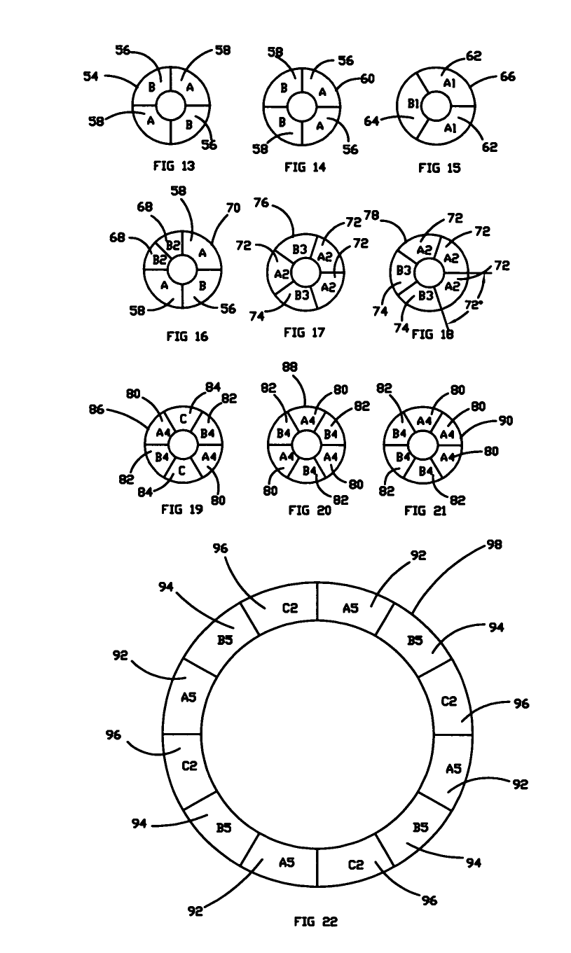

FIG. 22 is a schematic depiction of a twelve segment M-TCD 98 with three balanced segment sets 92, 94 and 96. Each segment set has four equal segments and in each segment set the inward force vectors sum to zero. In each segment set there are four segments configured in an equidistant polar array about the central of M-TCD 98. M-TCD 98 is capable of successfully engaging three separate rods of differing thread geometry. M-TCD 98 could easily be configured to have six balanced segment sets where each segment set would consist of two equal segments configured in an equidistant polar array about the central axis of M-TCD 98. Each segment set of two segments would have the sum of the inward force vectors sum to zero. Such an M-TCD would be capable of successfully engaging six separate rods of differing thread geometry. It is obvious that an almost limitless combination of segment sets and segment sizes in both balanced and unbalanced configurations are possible within an M-TCD. In general, balanced segment sets are the most effective and the more unbalanced a segment set becomes the less effective it becomes.

Referring to FIG. 1 this M-TCD is typically configured to move along threaded rod 4 in one direction (“ratcheting direction”) without rotation of M-TCD, and to resist motion in the opposite direction (“locking direction”) without rotation. For the purposes of describing M-TCD and related embodiments herein, the direction of motion whereby M-TCD moves along threaded rod 4 without rotation shall be defined as the ratcheting direction and the opposite direction of motion as the non-ratcheting or locking direction. In particular, in accordance with some embodiments of the present invention, M-TCD is typically configured to be engaged to threaded rod 4 such that a single downward hand movement of M-TCD down the length of threaded rod 4 will correspondingly move M-TCD in the ratcheting direction accordingly, to a desired or predetermined position on threaded rod 4. Once in place, an upward hand movement of M-TCD along the length of threaded rod 4 will be met with an equal and opposite force such that M-TCD will not move in the non-ratcheting direction. Rather, in order to move M-TCD in the upward non-ratcheting direction of threaded rod 4, M-TCD is rotated along the threads of threaded rod 4. The most common configuration with respect to M-TCD engaged to a vertical threaded rod 4 is where (when viewed from above) a counter clockwise rotation of M-TCD will advance M-TCD upward (non-ratcheting direction) with respect to threaded rod 4.

It should be noted that while the above description is provided with respect to upward (non-ratcheting) and downward (ratcheting) hand movements of M-TCD along the length of threaded rod 4, the direction of the movements of M-TCD may be arbitrary depending upon, for example, the orientation of threaded rod 4 to which M-TCD is engaged.

In some embodiments, M-TCD will ratchet whenever M-TCD is moved along threaded rod 4 a minimum of one-half (½) of a thread pitch in the ratcheting direction. That is, when M-TCD moves one half of a thread pitch the segment set that matches the rod thread will ratchet such that if forces try to move the segment set in the opposite non-ratcheting direction, a minimum of one segment will lock up and prevent motion in the opposite direction with respect to threaded rod 4. To implement ½ thread ratcheting 2 identical segments 6 are arranged opposite one another in two of the possible two positions (shown in FIG. 7).

In particular with respect to FIG. 7 and FIG. 9, each of the two segments are driven upwards and outward at a 30 degree angle relative to central axis 24 as a result of upper guide surface 12 (FIG. 9 shows guide surface 30 engaging bearing upper guide surface 12) engaging cap guide surface 30 as threaded rod 4 (or equivalently the M-TCD) is pushed in the ratcheting direction. In this case, with enough movement of the segments along direction 50 and 52 (FIG. 9), segments 6 will completely disengage the threads of rod 4, and re-engage when the next rod thread moves into position to allow the two segments 6 to move toward rod 4 center and re-engage the threads of threaded rod 4.

On the other hand, if the forces reverse in direction and threaded rod 4 is driven down in the non-ratcheting direction (or M-TCD driven up), segments will be driven toward threaded rod 4 and lock. The threads will stay engaged as long as the downward force exists because of the inward radial force pushing segments 6 toward threaded rod 4. The inward radial force is generated by load-bearing surfaces 18 of base 22 contacting segment load-bearing surface 16 of segment 6 (see FIGS. 4, 5 and 6). Also to be considered is the outward radial force caused by the interaction of thread flanks of rod 4 against lower thread flank 42 of segment 6 (FIG. 11). The inward radial force relative to axis 24 on segment 6 overcomes the outward radial force on segment 6 as long as the “flank angle”, the included angle between lower thread flank 42 of segment 6 and the upper thread flank 44 (FIG. 11) remains approximately 60 degrees (which is the standard flank angle for American Standard and Metric threads), and the angle of load-bearing surface 18, remains substantially 30 degrees relative to axis 24, and reversing forces (forces in the non-ratcheting direction) are present. The resultant inward force keeps the segments 6 engaged with threaded rod 4.

Moreover, in some embodiments of the present invention, the material used to construct segments 6 is chosen to have a yield point greater than or equal to the material used for fabrication of threaded rod 4. Even when the yield points are substantially similar between the materials for threaded rod 4 and segments 6, and one segment 6 begins plastic deformation, as soon as threaded rod 4 moves (that is, before all segments of the segment set are fully engaged and resisting the motion of the threaded rod), other segments 6 will start to engage threaded rod 4 to overcome the strength of threaded rod 4. Actual experiments have shown that upon application of an increasing load on rod 4 while engaged with segments 6, segments 6 will crush the rod 4 and the rod 4 will fail by separating in two, typically at a point just below the segments 6. That is, if the system is placed under increasing axial force between the rod and the M-TCD until failure occurs (in the non-ratcheting direction), the rod rather than the M-TCD is the element most likely to fail. The segments 6 are typically much stronger and transfer more load per thread 40 to the rod 4 than a standard hex nut with the same number of threads and of the same thread geometry because the M-TCD provides inward radial forces that place the material of segment 6 threads 40 in compression and not just in shear as is the case with a standard hex nut with non-moving thread elements.

Alternatively, the material for segments 6, may have a yield point substantially lower than that for threaded rod 4, in which case threaded rod 4 will still fail (i.e., give way or break off) before M-TCD is compromised if there is sufficient length of thread engagement.

Moreover, spring 10 in some embodiments is configured to have sufficient tension to cause segments 6 to close around threaded rod 4 even in the case where there is gravitational force is pulling segments 6 away from threaded rod 4 (for example, in the case where M-TCD is inverted). Indeed, if segments 6 are not driven toward the center of threaded rod 4 by spring force, segments 6, may move outward to the wall of cap 8 and remain in that position resulting in M-TCD not engaging with threaded rod 4.

Referring to the FIG. 9, the directional arrows 50 and 52 illustrate the line of action in which segments 6 are configured to move when M-TCD moves in the ratcheting direction with respect to threaded rod 4.

During final assembly of the M-TCD the cap 8 is aligned over the base posts 20 of base 22 and then cap 8 is pushed down over base 22. The posts 20 force cap 8 outward over the posts 20 until the downward motion of the cap 8 allows the press fit surface (FIG. 6) of base 22 to engage press fit surface 32 of cap 8 (FIG. 8) and be a press fit. The cap 8 now cannot be removed from the base 22 without damage to the cap 8. This accomplishes the final assembly of the M-TCD without the use of other fasteners.

Referring to FIG. 6, it is advantageous to employ a conical lead-in 26 to guide the M-TCD over the end of threaded rod 4 upon initial engagement of M-TCD to the end of threaded rod 4. The conical lead-in 26 causes installation of M-TCD over the end of rod 4 to be quick and easy as the conical lead-in 26 guides the end of threaded rod 4 to the center of M-TCD. The segments 6 then move according to FIG. 9 as previously described as segments 6 engage the end of rod 4.

Although various embodiments which incorporate the teachings of the present invention have been shown and described in detail herein, those skilled in the art can readily devise many other varied embodiments that still incorporate these teachings.

I claim:

1. A multi-rod thread clamping device comprising:
a) a cap and a base surrounding a plurality of movable segments wherein each of said segments has a threaded inner surface suited for engaging a threaded rod; and,
b) at least one spring flexibly directing said segments against said threaded rod;
wherein said plurality of movable segments include two or more segment groups wherein said threaded inner surface of each of said segments within each of said segment groups is capable of engaging a definite thread configuration of said threaded rod; and,
wherein said threaded inner surface of each of said segments within different of said segment groups is capable of engaging a different thread configurations of said threaded rod, thereby providing a thread clamping device capable of engaging different thread configurations.

2. A multi-rod thread clamping device as in claim 1 wherein said segments and said segment groups have a balanced configuration surrounding said threaded rod.
